(19) United States
(12) Patent Application Publication
(10) Pub. No.: US 2015/0317657 A1
(43) Pub. Date: Nov. 5, 2015

(54) Dynamic ads and group purchases on a movie theatre screen

(71) Applicant: Wesley John Boudville, Perth (AU)

(72) Inventor: Wesley John Boudville, Perth (AU)

(21) Appl. No.: 14/120,158

(22) Filed: May 1, 2014

(51) Int. Cl. G06Q 30/02; G06Q 20/32; G06F 17/30

(52) U.S. Cl. CPC G06Q 30/0206; G06F 17/30879; G06Q 20/3276; G06Q 30/0275

(57) ABSTRACT

A movie theatre shows a barcode on a projection screen. The barcode lets a patron buy tickets to movies shown in trailers. Using a phone to go from the barcode to a web page to buy tickets. The screen shows a table of purchases, with thresholds for discounted prices. Dynamic group purchasing of tickets by gamification in an interactive feedback loop. A theatre auctions ad slots. A trailer is replaced by one or more non-trailer ads if advertisers bid enough. A free market finds the value of trailers. A theatre inserts its location into the barcode of an ad. The advertiser finds where the patron is, who decoded the barcode. The theatre can encode an advertiser URL as a sound and play this when the ad plays on the screen. A patron decodes the sound and interacts with the advertiser.

### REFERENCES CITED

“Service-Oriented Architecture” by T. Erl, Prentice-Hall (2004), 013-1428985.
“Understanding GPS” by E. Kaplan et al, Artech House (2005), 15805-38940.
“Dynamic group purchases using barcodes” by W. Boudville, U.S. Pat. No. 8,655,694 (May 29, 2012).
“Two-dimensional color barcode and method of generating and decoding the same” by P. Cattrone, U.S. Pat. No. 7,478,746 (2009).
“System and method for decoding and analyzing barcodes using a mobile device” by O. Attia et al, U.S. Pat. No. 7,287,696 (Oct. 30, 2007).
“Mobile billboard advertising system and apparatuses” by E. Barlow, U.S. Pat. No. 7,882,653 (May 31, 2005).
“Apparatus and method for printing two-dimensional barcode and articles incorporating such barcode” by G. Athens et al, U.S. Pat. No. 6,631,012 (2003).
“Clock free two-dimensional barcode and method for printing and reading the same” by D. Lopresti et al, U.S. Pat. No. 6,115,508 (2000).
“Optically readable two dimensional code and method and apparatus using the same” by M. Hara et al, U.S. Pat. No. 5,726,435 (1998).
“Data Communication System” by P. Bergel et al, US Patent Application 20120084131 (Nov. 19, 2010).
“Multi-functional audio distribution system and method for movie theaters and other public and private venues” by A. Capretta, US Patent Application 20120095749 (Oct. 13, 2011).
“Display apparatus” by H. Mukawa, US Patent Application 20120044571 (Aug. 11, 2011).
“Using dynamic barcodes to send data to a cellphone” by W. Boudville, U.S. Pat. No. 8,348,149 (Jul. 28, 2011).
“Cellphone changing an electronic display that contains a barcode” by W. Boudville, U.S. Pat. No. 8,532,632 (May 16, 2011).
“Narrowcasting from public displays, and related methods” by T. Rodgriguez, US Patent Application 20100228632 (Mar. 3, 2010).
“Method and system for monitoring a display venue” by W. Redmann et al, US Patent Application 20110271295 (Nov. 4, 2009).
“On-site barcode advertising” by R. Steelberg et al, US Patent Application 20100114680 (Oct. 1, 2009).
[Web references are from April 2014]
akamai.com
edgecast.com
groupon.com
livingsocial.com
en.wikipedia.org/wiki/Content_delivery_network
en.wikipedia.org/wiki/Contextual_ad
en.wikipedia.org/wiki/Digital_cinema
en.wikipedia.org/wiki/Digital_film
en.wikipedia.org/wiki/Mobile_billboard
en.wikipedia.org/wiki/QR_code
en.wikipedia.org/wiki/Real-time_bidding
riotgames.com

### TECHNICAL FIELD

This submission relates to the showing of ads on a movie theatre screen.

### BACKGROUND

Often before a movie screening, trailers of future movies will be shown. This is generally considered the best way to advertise a future movie. First, the audience has shown by its presence that it is willing and able to pay to go to a theatre. Second, the immersive effect of the large screen and the attendant sound system is more effective than television ads or billboards or other traditional means in conveying an anticipated future viewing experience. This is especially germane because of the increasing effectiveness of various automatic ad skipping methods for television. Hence while any type of ads could be shown in the theatre before the main screening, in practice these are mostly movie trailers.

But a perennial problem for the theatre and the studios has been how to quantify this presentation of trailers. Traditionally, before the prevalence of cellphones, the patron would have to leave the theatre at the end of the movie, remember the trailers and later decide to go to a theatre, and not necessarily the same theatre chain, to buy a physical ticket to a movie she saw in a trailer. To simplify this for her, some theatres offer a means of buying electronic tickets on the Internet. She can do this from her home computer or mobile device. But when she does so, the theatre does not know in general that she has been influenced by seeing a trailer. It might ask her in the web page where she places her order, but she might decline to answer. Also, by putting extra items in a web page or sequence of web pages, this has the risk of confusing the visitor and thus lessening the chance that she successfully completes a purchase.

Even if she were to use her cellphone to buy a ticket while in the theatre watching the trailer, it is noteworthy that the theatre usually will not know that she is in the theatre. Its web server will see an Internet address for a web query (that originated from her device). But that address might be a temporary one dynamically assigned by her wireless provider from a set of addresses owned by the provider. Or, on the Internet network, the query might originate from the wireless provider's gateway machine, that sits on both the Internet and the provider's internal network. Any geographic data publicly accessible and associated with that Internet address will be a location of the wireless provider. In general, that location will likely be somewhere in the same city of the theatre.

In principle, the theatre could try to address this by its web server knowing accurately the times at which it has shown trailers. When it gets an Internet purchase for a movie during or soon after its trailer was shown, it might infer that the buyer was in the theatre. But often the web server is for all the theatres in that theatre chain. And each theatre could be a multiplex, with several screens. For this to be tried, the chain needs accurate temporal records of all its screenings.

Readers may note that the lack of ability to measure the effectiveness of trailers is common to most traditional forms of ads, like those in magazines, billboards and television.

Another background topic is the use of digital film in theatres. The movie, trailers and non-trailer ads that are shown using a digital film projector are all digital files on a computer disk, as opposed to being on celluloid film. However the advent of digital film has been simply to replicate the existing workflow in a theatre.

Given that all the video assets to be shown are files, the theatre can have the computer run a controlling program (like a command script) that has a list of what is to be shown in a given session for the screen that the projector displays on. This list can be predefined before the session. In this way, the theatre can essentially replicate its earlier workflow, when the videos were on film spools. With the advantage of not having to manually change spools.

### SUMMARY

A movie theatre shows a barcode on a projection screen. The barcode lets a patron buy tickets to movies depicted in trailers on the screen. Using a phone to go from the barcode to a web page to buy tickets. The projection screen can show a table of purchases, with thresholds for discounted prices. For dynamic group purchasing of tickets in an interactive feedback loop.

A theatre can auction ad time slots. The slots are currently used to show non-trailer ads, which are often of low quality and probably generate low revenue. The theatre unlocks potential extra revenue from advertisers willing to pay to advertise in given theatre locations and at given times.

The theatre can define a minimum bid for the time slot of a trailer. The trailer can be replaced by one or more non-trailer ads if advertisers bid high enough. Thus a free market can determine the value of movie trailers.

A theatre can insert its location into the barcode of an ad. Letting the advertiser determine where the patron is, who decoded the barcode.

The theatre can let an advertiser essentially show web pages on the screen. With the pages having a barcode. Patrons scanning the barcode can use the web pages they get to alter the projection screen.

A theatre can encode an URL as a sound (“chirp”) instead of or in addition to using a barcode on the screen. Another way for a patron to buy a ticket to a trailer movie. Advertisers of non-trailer ads can also do this.

### BRIEF DESCRIPTION OF THE DRAWINGS

FIG. 1 shows a user with a mobile device watching a theatre screen.

FIG. 2 shows a barcode and a table on the screen.

FIG. 3 shows a sequence of items on the screen, including a trailer table.

FIG. 4 shows a sequence of ad and trailer slots for a screen.

FIG. 5 shows a theatre with an auction of ad slots.

FIG. 6 shows advertisers sending ads to a CDN to send to theatres in a city.

FIG. 7 shows a controller writing a barcode with its location, into a video.

FIG. 8 shows frames of a video containing a barcode.

FIG. 9 shows a theatre server redirecting from a barcode to an ad server.

FIG. 10 shows a patron interacting with an ad on the screen.

FIG. 11 extends FIG. 1 to use sound to transmit an URL.

### DETAILED DESCRIPTION OF THE PREFERRED EMBODIMENT

What we claim as new and desire to secure by letters patent is set forth in the following claims.

This submission refers to our earlier submissions to the US PTO: “Cellphone changing an electronic display that contains a barcode”, filed 16 May 2011, U.S. Pat. No. 8,532,632 [“1”]; “Using dynamic barcodes to send data to a cellphone”, filed 28 Jul. 2011, U.S. Pat. No. 8,348,149 [“2”]; “Transmitting and receiving data via barcodes through a cellphone for privacy and anonymity”, filed 4 Oct. 2011, U.S. Pat. No. 8,707,163 [“3”]; “Colour barcodes and cellphone”, filed 16 Dec. 2011, 20130157760 [“4”]; “Mobile device audio from an external video display using a barcode”, filed 25 May 2012, U.S. Pat. No. 8,708,224 [“5”]; “Dynamic group purchases using barcodes”, filed 29 May 2012, U.S. Pat. No. 8,655,694 [“6”]; “Chirp to control devices”, filed 9 Oct. 2012, Ser. No. 13/573,823 [“7”]; “Barcode to enhance mobile multiplayer games”, filed 22 May 2013, Ser. No. 13/986,650 [“8”].

Primarily, this submission extends the methods described in “6”.

Here, when we refer to a mobile device, this typically can be a cellphone. And specifically, it can be a type of cellphone currently termed a “smartphone”. The distinguishing aspects of a smartphone, as compared to a cellphone that is not a smartphone, is that the smartphone has a screen and Internet access, and lacks a physical keyboard. In terms of technological trends and of the usage of the word ‘cellphone’, we suggest that these aspects might eventually be folded into typical properties of a cellphone. Other types of mobile devices that could be used in this submission might be tablets, notebooks, netbooks, electronic book readers, PDAs, Head Mounted Devices (HMDs) or digital cameras.

We will describe the use of 2 dimensional barcodes. Examples of these include QR and Data Matrix codes. But other types are possible, including 1 and 3 dimensional formats.

We refer to a theatre. Typically, this will mean both a given theatre location and a theatre chain. Also, in a given location, the theatre might have several screens, each in its own room. This is known as a multiplex.

The submission has the following sections—
1. Dynamic group purchases on the main screen;
2. Non-trailer items;
3. Shared screen;
4. Ad auctions;
5. Variable slots;
6. Changing the ads;
7. Interactive ads;
8. Ads plus dynamic group purchases;
9. Sound to transmit URL;
10. Intermission;
11. End of movie;

### 1: Dynamic Group Purchases on the Main Screen;

When below we refer to a theatre room, we mean the actual room in which a movie will be shown. We do not mean the foyer, where typically patrons can buy soda and popcorn (“concessions”), and where there are often posters advertising other movies.

In “6”, we described the use of an electronic screen on a side wall of a theatre room. The screen showed a barcode and a table listing the trailers that are being shown in this room during the current screening session. A patron, Jane, would scan the barcode with her mobile device. The resulting web page which appears on her device lets her buy an electronic ticket to a future screening of the movie advertised by a trailer.

Of course, she could buy several tickets. Note also that she does not have to specify the exact date on which she would attend a given future screening. Each ticket would typically be for a single use; where there might perhaps be some blackout dates specified by the theatre, during which she could not use the ticket.

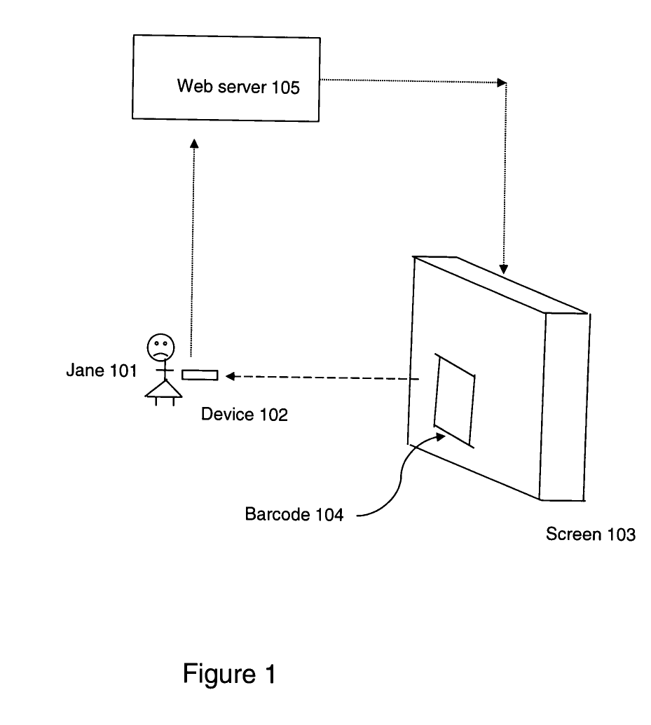

See FIG. 1. Jane 101 has a mobile Device 102. She is in front of the projection Screen 103.

The current submission focuses on the case where the table and possibly the barcode appear on projection Screen 103. A main point about this submission that distinguishes it from “6” is that here there is no separate screen on a side wall. This reduces the capital cost of implementing this submission, because the theatre does not have to pay for and install the side wall screen.

First, we consider why it is necessary to show the barcode. It encodes an URL. In the right hand side of the URL, after the domain part, is an identifier of the theatre room that Jane is in. When Jane scans the barcode with her device, the device decodes the URL and brings up a browser and loads it with the URL. That causes a query to Web Server 105 defined in the domain of the URL. Web Server 105 extracts the identifier and then from its records sends control signals or data to Screen 103.

The advantage of Jane scanning the barcode is that this can be just a one click action by her. Easier than the alternative of manually typing an URL that is written out somewhere in the room. Less prone to error.

For simplicity in FIG. 1, we omitted the computer connected via a wired connection to Screen 103, that controls it. This is a local computer, in the theatre complex. Whereas Web Server 105 might be located elsewhere. Implicitly in FIG. 1, that local computer is merged into Screen 103.

This is a feedback loop, using the barcode to let the user affect the contents of a large screen. This was first described in detail in our original patent “1”.

Second, where can the barcode be put? In “6” we gave two choices. One is to print the barcode out as a hardcopy poster. Put several instances of this on the walls, especially the left and right side walls which are often blank in most theatre rooms. The other way was to put it as part of an image on an electronic screen (or screens) on the side walls.

In the current submission, we suggest two choices. The first is like in “6”, putting hardcopy posters on the side walls. Or perhaps even on some or most or all of the backs of seats. The other is to put the barcode as part of the image on the main projection screen.

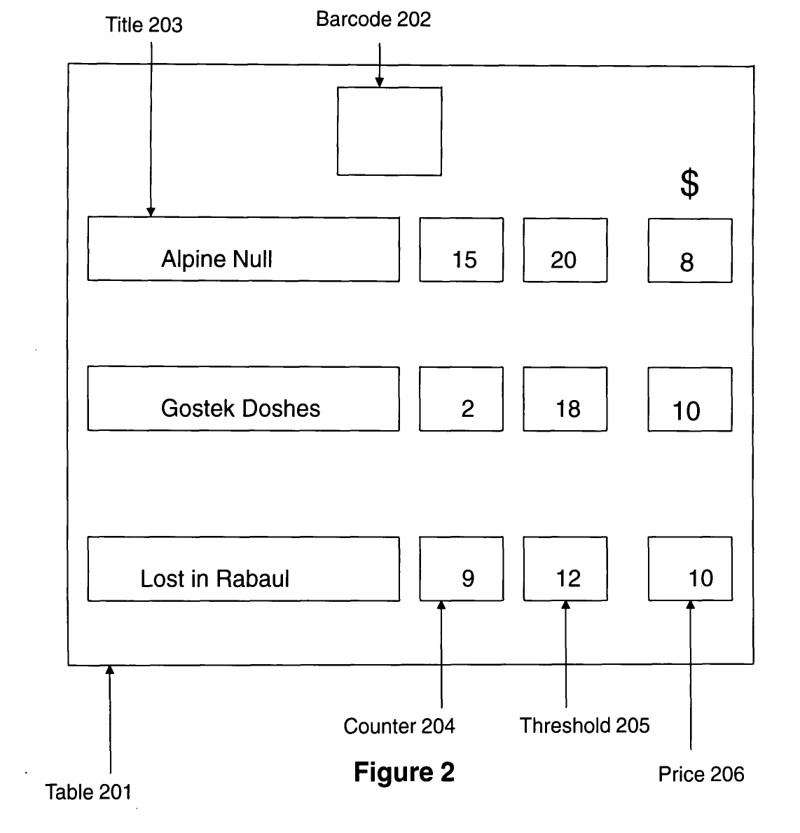

We now refer to FIG. 2. This appears on the projection screen. It shows Table 201 of trailers, where the trailers have appeared or will appear on the screen in the current session. Each line in the table is for a given trailer. The title of the trailer movie is shown in the column Title 203. Next to it is Counter 204 that indicates the number of tickets bought by patrons in this room, using the above method of scanning the barcode. The counter starts at 0. When the first ticket is bought, it goes to 1, and so on.

Next to it is a fixed number, Threshold 205. When the counter reaches this value, the price per ticket falls for everyone who has already bought. This is a volume discount or group discount. It is important that it applies to all those who already bought. This does not penalise those who bought early. Thus it encourages liquidity in this marketplace.

Optionally, the table can show the current and next (lower) price, in the column Price 206. To further encourage purchases.

FIG. 2 also shows Barcode 202. If the earlier choice was made to show the barcode as printed hardcopy elsewhere in the room, then Barcode 202 can be omitted from FIG. 2.

The use of the main screen to show FIG. 2 raises the question of when this can be done. One method is to show it after each trailer for which tickets can be bought using the above mechanism. This allows for the possibility that some trailers are excluded.

Currently, many theatres are moving or have moved to a fully digital data stream that is shown on the projection screen. This includes both the main movie and the trailers and other non-trailer ads.

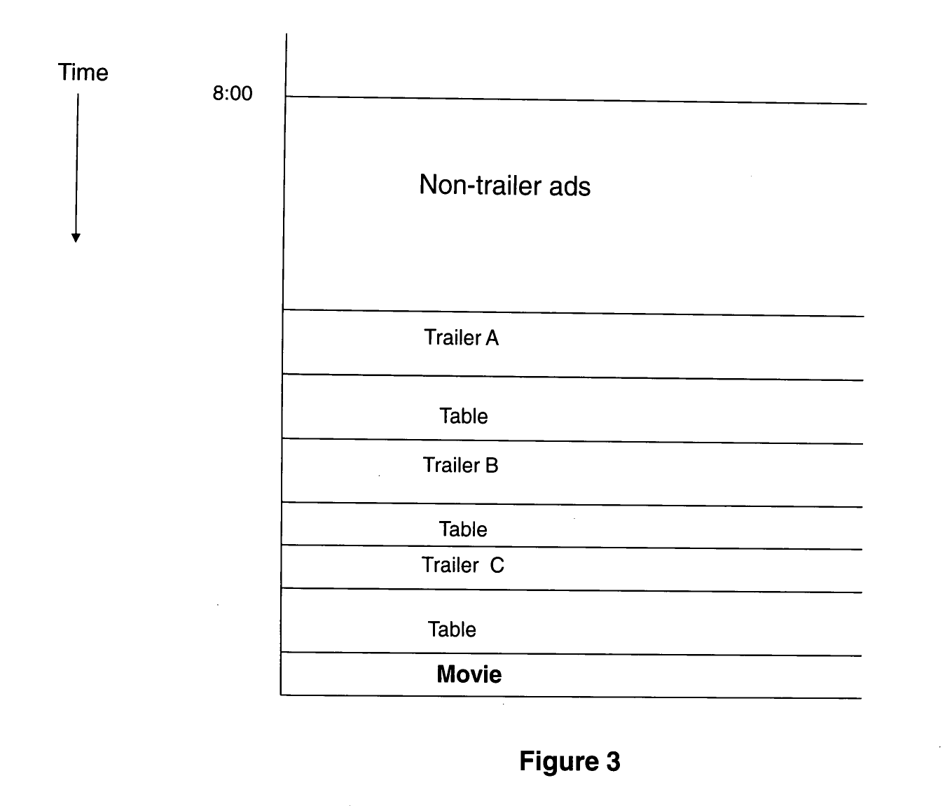

Using this, we have FIG. 3. It shows the temporal flow of what is shown on the screen, with time running from top to bottom. Imagine that the session starts at some time, like 8 pm. First, non-trailer ads are shown. Then trailer A is shown. Then the table of FIG. 2. Here, the table might be only one line, just for trailer A, or it might also show lines for trailers that have not yet been shown. The table appears for some time. Then trailer B is shown. Then the table. Then trailer C. A final showing of the table. Ultimately, the movie appears.

The durations of each time the table is visible might be the same. Or they might vary, perhaps determined by control logic in a computer program. The program might be running on a local computer in that theatre. Or it might be an extension of the Web Server 105 on a non-local computer.

In general, it would help for the table to be visible as long as possible. To give patrons more time to be influenced by it. By seeing the counter increase and approach the threshold. The tradeoff is that the longer the table is visible, the less time to show the next trailer or non-trailer ad.

The controlling program might use the counters and their values and rate of change as a factor in determining how long the table is visible, in any given period when it is visible. We say counters, because there is a counter for each trailer line in the table.

For example, if the counters are increasing at some rate (that is, patrons are buying tickets) greater than some value, then the table could stay visible longer. People are interested enough in the trailers to be buying. So keep the table on the screen until the purchases appear to have tapered off, either to zero or to some low value over some duration. There could be some maximum duration for which the table can be visible. Because ultimately the movie for which the patrons have paid has to be shown.

Given that there might be several counters, there could be various means to make this decision about keeping the table visible. For example, a simple way would be to just sum up all the counters, and see how this total is varying over time.

### 2: Non-Trailer Items;

The table was used above to just show trailer titles, to sell tickets to those movies. But the table can also be used to sell concessions; i.e. the soda, popcorn and other refreshments that are typically offered in the foyer.

Again, as for trailers, there could be the group discount or gamification aspect. If enough people order a given concession, as determined by the reaching of a threshold, then the price falls for everyone. Lucrative for the theatre since it can retain all of this revenue, unlike movie trailer tickets, for which it has to share with the studios.

Another advantage of this is that currently there is an inertia and an obstacle course effect that inhibits some patrons from leaving their seats to buy refreshments if they have not already done so. Or if they have, but now want more refreshments. There could be other patrons already seated between them and the aisle, making it awkward for them to get up and leave to buy.

Our method lets them buy while seated.

Extending this, the theatre can offer the delivery of the refreshments via ushers. When the patron places an order on her phone, the web page might ask for her name or nickname or seat number. Or some other equivalent datum. Essentially, the theatre can batch the orders from several patrons. For efficiency in filling out those orders and then having an usher deliver several orders at a time.

This method of selling refreshments can be in addition to the main method of selling tickets.

Both can be combined in various ways. For example, if a patron buys more than one ticket to a trailer movie, or buys several single tickets to several trailer movies, then the theatre might offer her refreshments at discounted prices.

Going further, if the theatre already knows other data about her, perhaps if she has bought using the methods of “6” or this submission, during previous visits to the theatre, then it might customise the offers based on that data. Whereas the steps in the previous paragraph might be used with the same parameters, for all patrons whom the theatre does not know any past history.

### 3: Shared Screen;

Above, we described how the table would appear by itself (or perhaps accompanied by a barcode) on the main screen. Another possibility is that part of the table could appear during the showing of a trailer. Specifically, when a trailer is being shown, a portion of the screen might show the line in the table referring to that trailer.

Since the entire data stream on the screen is digital, this would involve minimal (if any) alteration of the trailer data. The table line could be done as an opaque overlay at the bottom of the screen, for example. A trivial graphical effect.

In addition, the entire table might still appear on its own screen as described earlier. The steps in this section are not meant to be exclusive.

### 4: Ad Auctions;

We assume a theater is using digital film. The movie, trailers and non-trailer ads shown on a theatre screen are all digital files on a computer disk associated with or accessible to the digital film projector. We also assume that the projector or, equivalently, a computer that controls it, has Internet access. The controlling computer would likely be co-located somewhere in the theatre multiplex. Or perhaps it is considered part of the projector.

Before the movie is shown in a theatre, ads are shown. These are trailers and non-trailer ads. Typically, there is a big contrast in sophistication between the two. Trailers are good in emphasising the key points of the movies they promote. But the non-trailer ads are usually done on much smaller budgets. Some might be public service announcements (e.g. “do not smoke in the theatre” or “turn off your phone when the movie starts”).

Probably the theatre derives little revenue from showing the non-trailer ads. This section offers a method to make more revenue from the ads.

Currently, suppose a user, Jane, sits at a desktop computer at home and surfs the Web. When Jane arrives at some domain, it might be able to extract some knowledge of her surfing patterns and any other information about her. This could be done via cookies and via a network of affiliated domains that could access that data. What happens at some websites is that the site auctions off her presence at one of its web pages. Other sites bid for the right to present their ads on the first site's page that is being currently requested by Jane. All this can happen in the second or so that it takes the page to be downloaded to her computer. Via a Real Time Bidding (RTB) network.

Or, consider when Jane goes to a search engine on her computer, like Google Corp. She types in “car”. Prior to this, the search engine may have auctioned off the search term “car”. Advertisers bid to be on the paid links on the results page. These are known as contextual ads.

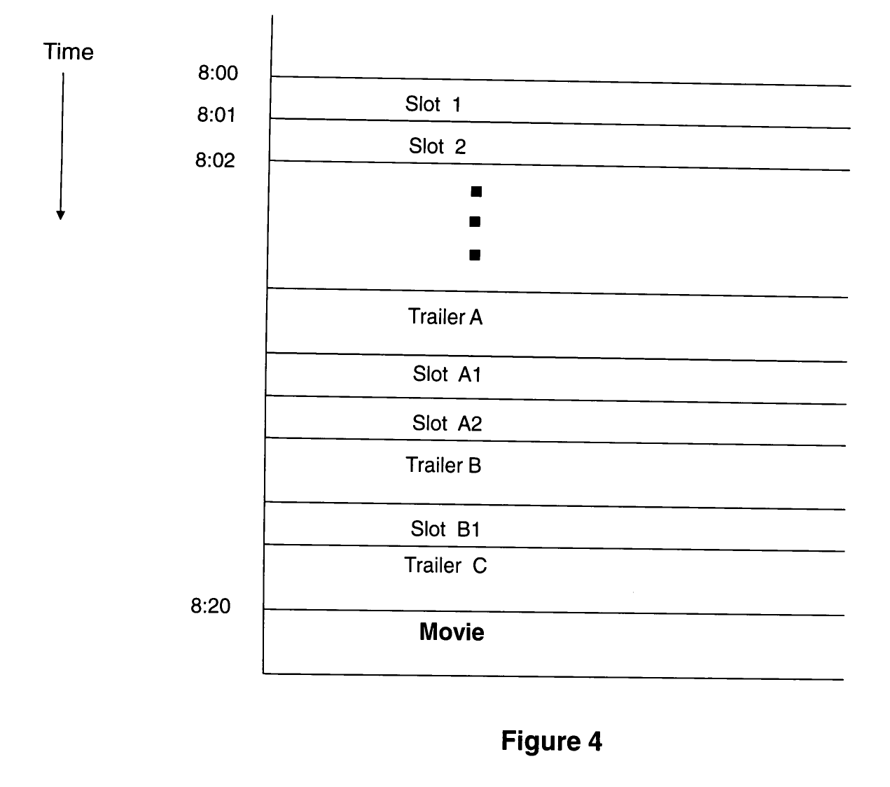

Now consider how the prior art in the previous paragraphs might be modified and extended to the scenario of ads on a theatre screen. FIG. 4 shows an example for a given theatre screen. Assume this is for an 8 pm movie session on a given night. Time increases from top to bottom on FIG. 4. There is Slot 1 for a non-trailer ad, which is from 8:00 to 8:01 pm. Followed by Slot 2, from 8:01 to 8:02 pm. Etc. Eventually trailer A will show. Followed by what we term Slot A1 and Slot A2. Here the notation just means that these 2 non-trailer ad positions occur after trailer A. Then trailer B is shown, followed by one slot B1. Then trailer C is shown. Finally, the movie itself is shown.

For simplicity, we depicted the starting Slot 1 and Slot 2 as being 1 minute each. In practice, they could be shorter or longer, and of different durations.

Also, we showed two slots after trailer A and one slot after trailer B. Currently it is more common that once trailers start showing, then usually only trailers are shown till the movie starts. But in FIG. 4 we treat a more general case of non-trailer ads interspersed between trailers.

FIG. 4 only depicts 3 trailers. But there could be more or less than this number.

The theatre at the simplest level of this section can auction these slots before the 8 pm session starts. But what is the equivalent (if any) of Jane's cookie or of her search term, to hand over to potential advertisers? In part, this is one of the new features of this section vis a vis the earlier mentioned state of the art for users surfing the web.

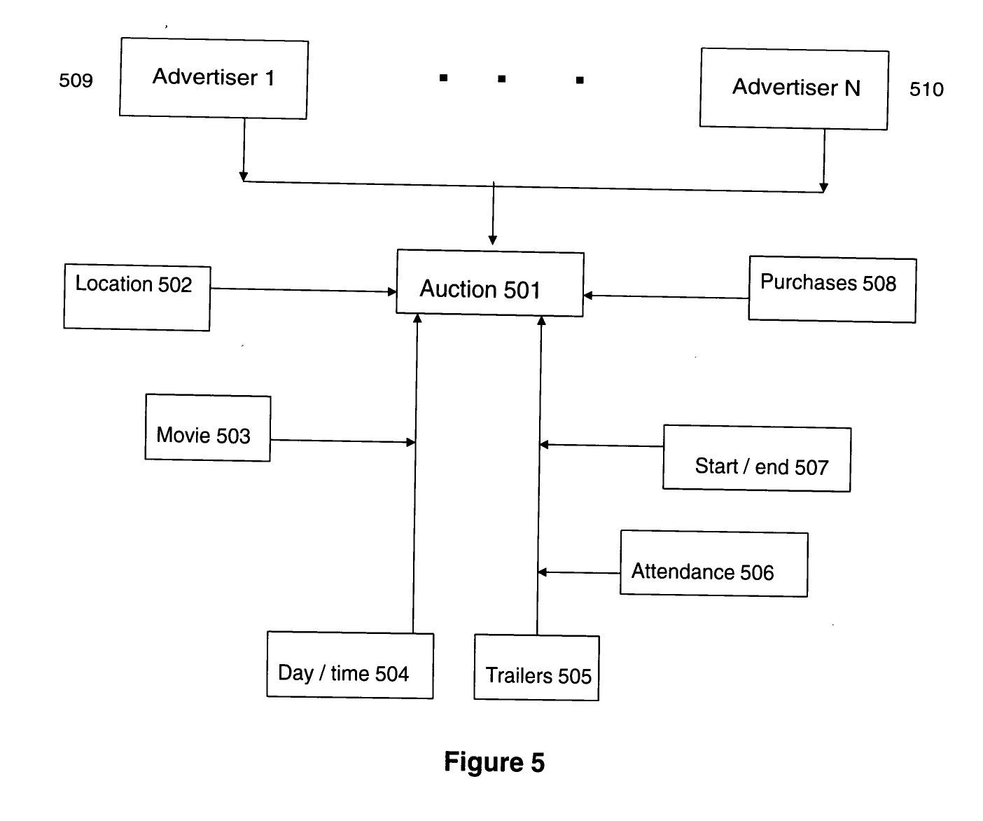

The theatre can offer the following information to advertisers. The following data are optional, but recommended. See FIG. 5. Auction 501 is conducted online (i.e. on the Internet) by the theatre.

The first data is the location of the theatre screen, Location 502. Here, remember that by “theatre” we mean a theatre chain, which might be national. The location of a given screen can be given in some standard format, like latitude and longitude. The point is that a theatre screen in an affluent neighbourhood (e.g. Beverly Hills, Calif. or Gross Pointe, Mich.) might have more value to the advertiser than a screen in a working class area.

The second is indicating which Movie 503 will be shown in the given session. Suppose it is a spy movie, where an Italian luxury car is depicted, and also an expensive brand of whiskey. Vendors offering those items might find value in showing their ads prior to the movie. Or competing vendors offering other luxury cars or expensive whiskey might also be interested in the slots.

The third is the date and session time, “Day/time 504”. A weekend evening session might attract more patrons than a weekday evening session. Where here to some advertisers, the weekend might be from Friday evening to Sunday evening.

The fourth is telling some information about the Trailers 505. Assuming that the theatre has already picked those trailers. So for example, suppose trailer A is for a romance movie. Then slots A1 and A2 might be valuable to advertisers offering romance-themed items like wedding rings or flowers. Or, for that matter, a slot prior to but near temporally to the showing of trailer A.

The fifth is telling some information about the recent attendance history (Attendance 506) of this particular room that has the screen. Or perhaps some measure of the attendance across all the screens at this location. (Assuming that the location is a multiplex.) Because of the potentially sensitive nature of this information, some theatres might not want to divulge actual numbers. So there might be a proxy, like the theatre indicating on a scale of 1 to 5, where 1 is the lowest, what the attendance has been. A relative indicator of attendance.

The sixth is, of course, the start and end times of the slots being put up for auction. “Start/end 507”.

The seventh is the recent purchase history (“Purchases 508”) by patrons in this room. To the extent that this is known by the theatre and that the theatre is willing to disclose to bidders. For example, elsewhere in this submission, and earlier in “6”, we described methods for the theatre to sell tickets to future movies depicted in trailers. Or, in a reflexive loop, using methods here to let advertisers sell items via the projection screen. Data from previous sales can be used to offer bidders guidance.

This can be extended to sales information about other screens in the same theatre complex as a given screen.

FIG. 5 shows item 509 as Advertiser 1 and item 510 as Advertiser N, where there is some multiplicity of these advertisers. The figure shows the advertisers going to the theatre Auction 501. Implicitly, this means they connect online to a web site or Web Service run by the theatre. The site or Service would be for all the theatre locations in the theatre chain. Though the chain can always have any given theatre not be represented. The item Auction 501 in general represents the auctioning of ad slots at different theatres in the chain, at different screens in a given theatre building, and at different days and times within a day.

In FIG. 5, the advertiser boxes are depicted with arrows going from them to Auction 501. Suggesting that the advertisers either manually or via computer programs go to the site or Web Service. Another possibility is that the site could send or publish or push the auction data to one or more advertisers. We consider the terms “send”, “publish” and “push” to be equivalent in this submission.

Also, some advertisers might go (“pull”) to Auction 501 while others might get data pushed to them. The theatre can offer both features.

An advertiser could use any combination of the above information. Along with other data that it has access to, and which the theatre might not have access to, in determining which screens and when it would like to advertise. For example, it might combine the screen location with a date to find where and when. Suppose a theatre is near a convention center, and the advertiser will be having a booth or will be advertising heavily at an upcoming convention. The advertiser might coordinate this with an ad campaign at nearby theatres. Maybe making the assumption that people watching at those theatres, before the convention, might be more likely to attend the convention, due to their existing proximity.

Note also other differences between the above steps for a theatre screen and when Jane surfs the web on her own computer.

First, the theatre screen is for a group of viewers, patrons. While when Jane surfs the web, she is usually by herself on her own computer.

Second, the theatre screen has no keyboard, keypad, mouse or other input peripherals that the patrons can access, to affect what is shown on the screen. While when Jane surfs on her computer at home, she controls one or more of these input peripherals.

Operationally, for whatever information the theatre offers advertisers, there might be a predetermined data format (e.g. in XML) that is used. The theatre might have a Web Service that advertisers' computers can query on the Internet.

This lets each advertiser develop its own methods to discern value in each slot. Each advertiser has its own utility function, in the language of economics.

Now suppose that the theatre has before the 8 pm session promulgated the information (whatever that might be) about the session, and advertisers have entered bids. The theatre can choose whatever auction mechanism it wants, to pick winners for each ad slot. Advisedly, it should tell the bidders beforehand some details about this mechanism, so that they perceive it as fair.

This submission is not about devising a new auction algorithm, but rather to develop a novel situation and framework for auctions to be used.

As a practical matter, the theatre (chain) might have a pre-qualified list of advertisers. To prevent arbitrary advertisers of perhaps unknown reputation to successful show ads on the theatre screen.

Also, there is the matter of ensuring that the successful ad can actually get shown in the time slot for a given screen. The theatre might require that the successful advertiser, who won a time slot, push the ad to a computer in that theatre location. Or to a computer of the theatre chain, located in the same town as the given screen.

Equivalently, a third party service might be involved, like a Content Distribution Network (CDN), e.g. Akamai Corp. or its peers. In general, this is exactly the purpose of a CDN, which has nodes scattered over the Internet for timely rapid access to files.

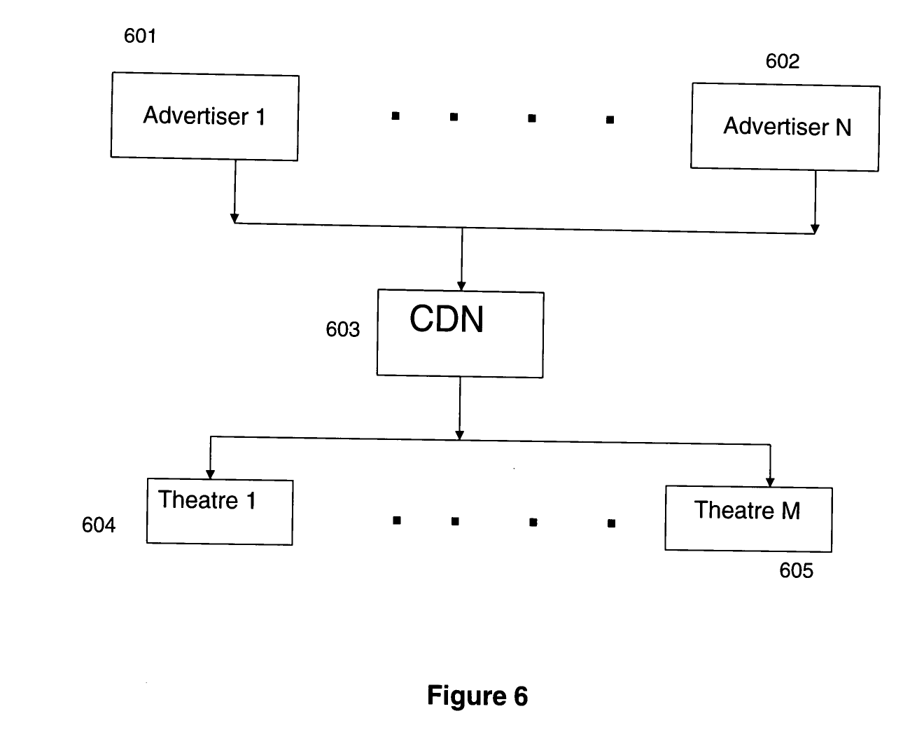

FIG. 6 shows a use of a CDN. Item 601 is Advertiser 1, Item 602 is Advertiser N, where there is a plurality of these advertisers, all on the Internet. CDN 603 is a CDN site, assumed to be in a given city. The advertisers send their ads to CDN 603. Item 604 is Theatre 1 and item 605 is Theatre M, where there is a plurality of these theatres in the same city. CDN 603 makes the ads accessible to the theatres. They are part of the same theatre chain. Note that CDN 603 can be replaced by an office of the theatre chain in the city.

The choice of using a CDN or using a theatre office is not mutually exclusive. Some ads might be held in a CDN while others are held at a theatre office.

A variant is where an advertiser pre-positions ads at the CDN or in a theatre computer. These ads are not yet approved for display at any given screen and display time. At some later time, the advertiser bids for a time slot. If it wins, then the ad contents are already available to the theatre.

This also has the effect that the theatre can inspect the pre-positioned ads, to check that they are appropriate for display. This might be important for when a movie is G rated, say. The images and audio of an ad might need to be compatible to the movie rating.

### 5: Variable Slots;

The previous section described ad slots fixed in starting time and duration. More generally, the theatre might let advertisers bid for variable time slots, where one or both of the starting time and the duration might be variables over some ranges of values. The theatre could apply various optimisation methods to maximise the value it can extract for selling off the slots.

Also, the previous section had the trailers as predetermined, prior to the auction. The theatre might assign a value to one or more of these trailer slots. So the trailer slot itself might be eligible to be replaced by one or more non-trailer ads, if those advertisers bid enough to be greater than that value. That value functions as the equivalent of a reserve bid in a traditional auction.

The advertisers might be operating cooperatively or independently.

The advantage to the theatre is that it lets a free market determine the value of a slot, for a trailer or a non-trailer. A fundamental change from the current situation, where it is often essentially just an estimated price determined by one on one negotiations with a studio.

The theatre could let the successful buyer/s of a slot resell it; including being able to break it up into shorter slots and reselling those. Or the theatre might let another entity be a reseller for many slots across much or all of its chain.

### 6: Changing the Ads;

The previous section talked about how a screen's location and the date and time of a session could be used by an advertiser to determine what slots it wants to put its ads in. This section shows how the ads themselves might be altered as a function of where and when they are shown.

Consider an ad to be shown on a given screen. So the location is fixed. The ad might be shown at different times. The ad will show a barcode containing some information. The advertiser wants the patron to scan the barcode and get the information. Suppose the encoded data is an URL, pointing back to the advertiser's web server. But the advertiser had also bought time slots at other theatres in this chain, in the same city and perhaps in other cities. Essentially the same ad will be shown, at approximately the same times. But the advertiser would like to know which theatre the patron was in, when she scanned the ad.

At the simplest level, this lets the advertiser measure the efficacy of the ad, as a function of theatre location. So that in future, for example, it might focus on bidding for ads to be placed in theatres where many patrons had scanned its earlier ads. Or it might want to place different ads at different locations, catering to regional variations in customer demand.

Why can't the advertiser's web server just use the IP address of the patron's device, when she contacts it? And then map from the address to a location. A problem might be if the patron has a cellphone and contacts the web thru the phone carrier. The carrier would dynamically assign the phone a temporary IP address. But in the Internet databases, this IP address would be associated with the phone carrier at some location in the city. There would be insufficient information to indicate which theatre in the city the patron was in.

Or why can't the web server just ask the patron's device for its coordinates? The patron is inside a building. Her device cannot see the GPS satellites. Unless perhaps the theatre has installed extra hardware that lets location information be gotten by her device. Some devices might use their last known GPS location; presumably when the patron was outside and near the theatre. But another problem arises. In general, the patron has to explicitly allow external servers to get her device's location.

It is much simpler if the URL in the barcode had the theatre's location encoded. Or maybe an identifier of the theatre. In the latter case, the ad server extracts the identifier from the URL and then looks up a table to find which theatre the patron is in. Whereas in the former case, the server extracts the location from the known format of the URL. Then it looks up a table of the theatre locations to find the theatre.

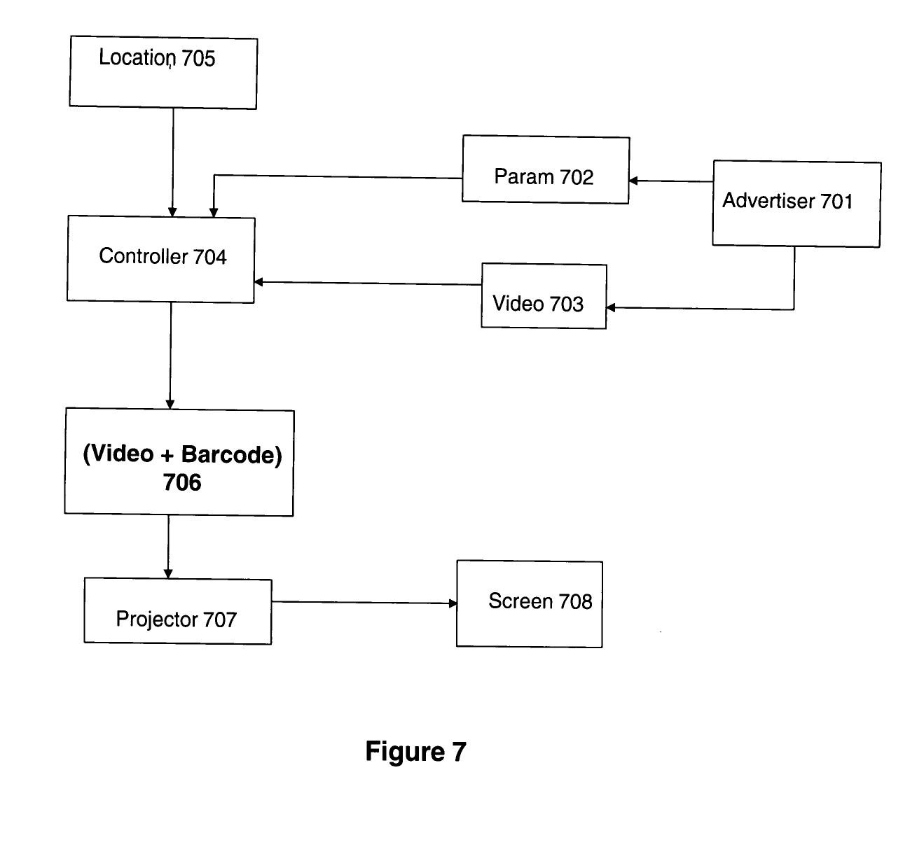

FIG. 7 shows show how this can be done. Advertiser 701 sends a Video 703 to Controller 704. This video is the ad described in previous sections. Controller 704 is the computer at the theatre that sends its output to the Projector 707. Now, Advertiser 701 also sends Param 702 to Controller 704. Param 702 is a set of parameters that will define a barcode to partially overlay Video 703. Controller 704 knows its location information, Location 705. The latter can be found by any cartographic methods, including satellites.

Note that the latter does not contradict the earlier statement that a patron inside the theatre likely has no direct access to GPS, because she is indoors. For the theatre itself, all it needs is a receiver outside, that can access GPS. Or, more simply, the Location 705 information might be manually input into a suitable place in Controller 704's memory or disk. Location 705 might be found by a person working for the theatre, who goes outside with a GPS enabled device (like many current cellphones) and just reads off the location on the device's screen.

Controller 704 then uses Location 705, Param 702 and Video 703 to make “(Video+Barcode) 706”. This designates where Video 703 has been altered to have a barcode that encodes Location 705. This output is sent to Projector 707, which then shows it on Screen 708.

When Controller 704 makes (Video+Barcode) 706, it might not immediately send this to Projector 707. As discussed earlier, this video might be computed and then stored in Controller 704. Awaiting the appropriate time slot when it should be sent to Projector 707.

An alternative, which is essentially equivalent, is where Controller 704 does not make (Video+Barcode) 706 until the time has neared the time slot for when it should appear on Screen 708.

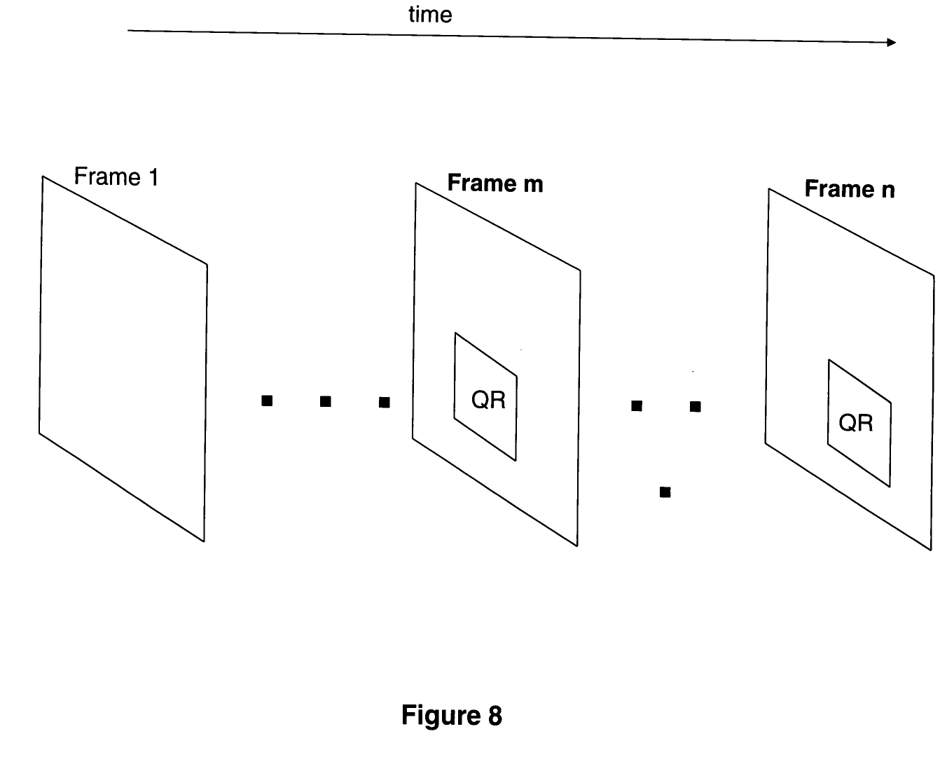

FIG. 8 shows what (Video+Barcode) 706 might look like. The flow of time is from left to right. Frame 1 is the first frame. From this frame to Frame m−1, there is no inserted barcode. Then from Frame m to Frame n inclusive, there is an inserted barcode. This is indicated by the region QR in those frames. Note that there might be more frames after Frame n. If so, these frames would not have an inserted barcode.

We chose to designate the barcode by QR, which stands for the QR barcode. Other barcode formats are possible.

Note that there are various video compression formats, like MPEG or MOV. FIG. 8 shows each frame in the ad. But it is highly inefficient to actually store the ad as frame by frame. But whatever compression encoding methods are used, during the decoding, the controller or projector gets back the equivalent of FIG. 8.

Now consider what Param 702 might have. This is a set of parameters necessary to tell Controller 704 what to insert. The parameters might preferably include an URL pointing to the advertiser web server. (More on this later.)

The parameters can include the frame indices m and n of FIG. 8. m is the index of the starting frame that will have the barcode, and n is the index of the ending frame. Clearly, another equivalent choice might be m and then the number of other frames containing the barcode (=n-m+1).

Another parameter might be an integer that designates the type of barcode. A value here of 0 might be QR. A value of 1 might be Data Matrix. Etc. All these would be well known barcode formats, for which Controller 704 can make the appropriate barcode.

Another set of parameters would indicate the location on the frames where the barcode would be placed. There could be (x,y) for a corner of the barcode rectangle. And then (dx, dy) for the lengths of the rectangle in the horizontal and vertical directions.

All the barcode formats are assumed to be rectangular. Though if a barcode format would ever exist that used a non-rectangular area, suitable parameters could be devised to handle that case.

The above assumes that the barcode will be at a constant location in the frames that it appears. Desirable because the patron will have to focus the camera of her mobile device on the barcode to scan it.

Now what should the barcode encode? One practical choice is that the encoded data is an URL. Suppose Advertiser 701 has a web server at its domain, waiting for URL queries from browsers running in patrons' cellphones.

In the URL, to the right of the domain would typically be various pairs “a=b”, separated by “&”, where “a” is a label and “b” is the value. The advertiser could deliberately send an incomplete URL. Where it also sends in the parameter list the name of a latitude label and the name of a longitude label. Suppose the former is “r” and the latter is “s”. Then the projector would append something like “r=18.054&s=140.531” to the URL sent by the advertiser. This would later be decoded at the advertiser server to extract the coordinates of the theatre in which a patron scanned the barcode in the ad. There might be a default number of significant figures that the coordinates are written in.

An alternative method offers a shorter URL. Instead of explicitly writing the coordinates into the URL, the Controller writes an identifier of the theatre. Where the parameter list from the advertiser might have the name of the label that will refer to this value. In general, a shorter URL to encode as a barcode is desirable. Because it means the barcode is easier to decode by cameras in the patrons' devices.

In this case, the theatre web server (which would likely be for the entire theatre chain) can offer a Web Service. When presented with the id of a theatre, it returns the coordinates. So the advertiser server would get the theatre id and then present it to the theatre server.

A separate but related use for the theatre web server is as follows. The URL that appears on the screen refers to the domain of the theatre web server. When a patron scans the barcode URL, her device goes to that server which then redirects to the actual URL of the advertiser. This is similar to how, for example, Google Corp.'s paid ads on the right hand side of its search result pages go to its server.

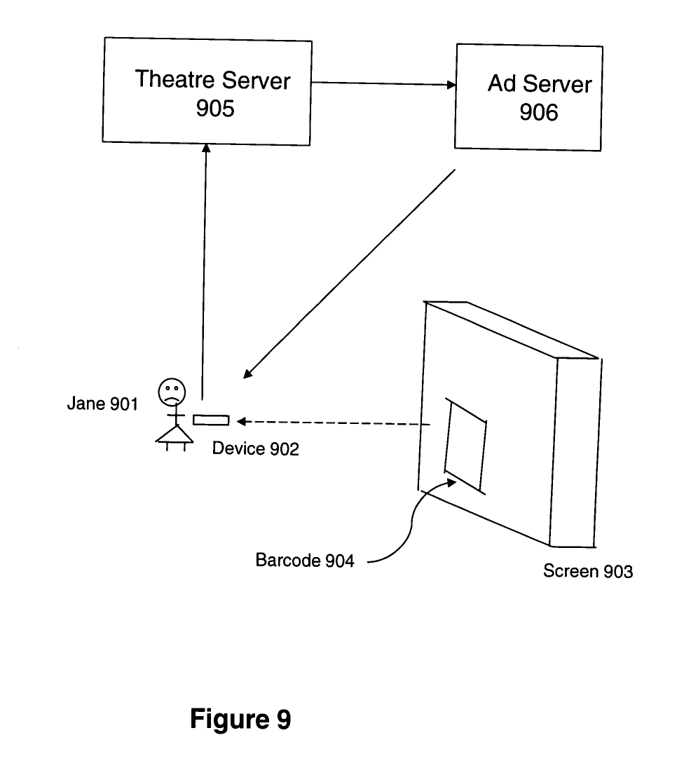

FIG. 9 describes this. Jane 901 uses her mobile Device 902 to scan Barcode 904 which appears on Screen 903. When Device 902 decodes Barcode 904, it contacts Theatre Server 905, which looks up in its internal database the URL that goes to Ad Server 906. The network address of Device 902 is put as the source address in an Internet query, and the query is made to Ad Server 906. The latter uses the address of Device 902 to reply directly to it, as shown by the arrow from Ad Server 906 to Device 902.

There are two advantages for the theatre use its server in this way. First, like Google, if the theatre gets paid by the advertiser on a per click basis (where here “click” means a scan by the patron device), then its server can count the “clicks” (scans). Otherwise a barcode URL that only goes to the advertiser server might tempt the advertiser to report an undercounted click rate to the theatre.

Second, the theatre might be able to use a shorter URL than the URL from the advertiser. This makes the barcode on the screen easier to scan from a patron device. There is no analog of this reason in the Google ads.

This case of using the theatre server does not depend on whether the theatre injects any location information into the URL.

Earlier, we looked at how the location of the theatre can be put into the URL. Similar remarks can be made to also use the date and time of when the ad is shown. As well as other possible data. In FIG. 7, we replace Location 705 with an appropriate source of whatever new data should go into the URL.

### 7: Interactive Ads;

The previous section described how an advertiser can get the theatre to automatically put a unique barcode URL into the ad. So the advertiser can get responses from a known location, to measure the efficacy of its ad at that place.

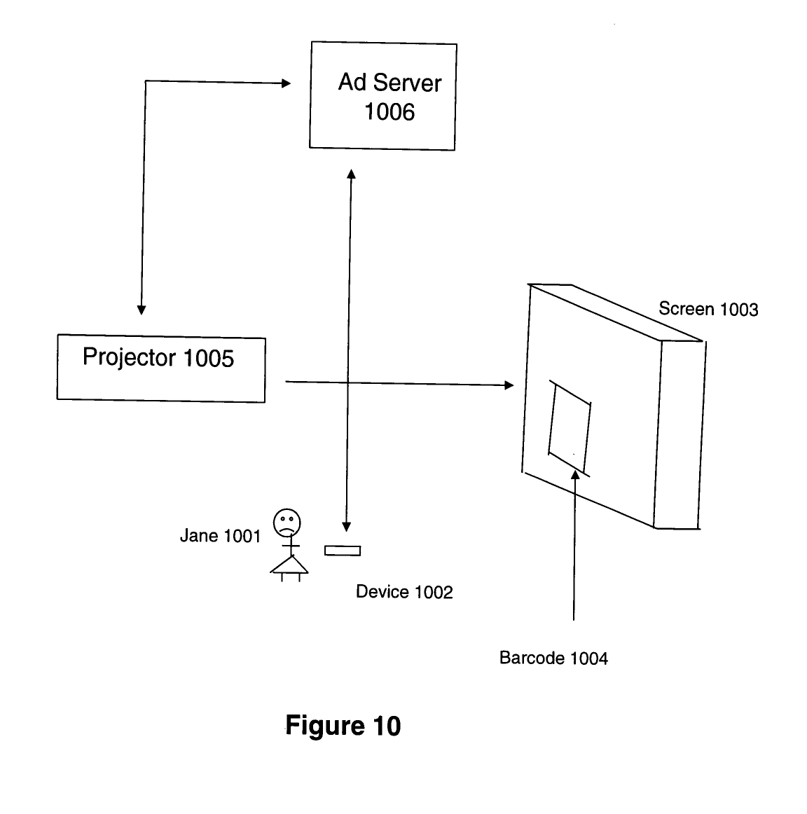

This idea can be extended much further. The key observation is that the theatre has an Internet connection. And its digital projector controls every pixel on the projection screen. See FIG. 10. Jane 1001 has a mobile Device 1002, and is in front of Screen 1003. Projector 1005 makes and thus controls the content on Screen 1003. For simplicity, we merged the theatre Controller computer of earlier figures into Projector 1005.

Suppose the advertiser bought an ad time slot, and we are now at or just before the start time of the slot. Projector 1005 contacts the advertiser Ad Server 1006 and asks for the ad.

A simple implementation is that the ad is done via a series of web pages. Ad Server 1006 sends web pages to Projector 1005, which then shows these on Screen 1003. So the combination of Projector 1005 and Screen 1003 is equivalent to a digital screen of a personal computer, and Jane is in front of that computer. With the important caveat that there is no keyboard, mouse or other input peripheral of that “computer” accessible to her. Which is why the web page on the screen shows Barcode 1004. When she scans it with her device, it decodes and contacts Ad Server 1006. Which then sends content to Projector 1005 and Device 1002.

Note that it is irrelevant whether the URL in Barcode 1004 goes first to Projector 1005 or directly to Ad Server 1006. Though for efficiency, it should probably do the latter.

When Projector 1005 gets the web pages, it can preferably show the pages on Screen 1003 without an explicit browser around those pages. This frees up the entire screen for graphics and improves the immersive nature of the interaction for the patrons. There is no useful point to showing the browser border, with the various browser buttons in that framework. These cannot be accessed by the patrons.

More generally, the content that Ad Server 1006 sends to Projector 1005 need not be web pages. It can be arbitrary graphics (along with any accompanying audio). This gives more artistic design freedom to the advertiser.

At the end of the ad time slot, Projector 1005 disconnects from Ad Server 1006. It goes on to show the next ad or the main movie.

Thus the advertiser ad can be an interactive application. When patrons scan the barcode, they get webpages from the advertiser server. Those pages can be used by the patrons to affect the display of the screen during the ad. Hence several patrons might play a game on the screen. Moving their pieces by pressing various buttons or links on the pages on their phones. This interactivity can lead to better mindshare of whatever is being advertised in the ad. Not just by those playing the game, but also by the rest of the audience.

### 8: Ads Plus Dynamic Group Purchases;

The previous 4 sections deliberately had little in common with the earlier sections that were about dynamic group purchases of movie trailer tickets. The current section combines the two ideas.

Consider FIG. 4 again. Now imagine some slots have deliberately not been sold by the theatre, prior to the 8 pm session. Suppose these are the slots after the first trailer has shown.

Further, suppose the theatre was successful in selling tickets to trailer A. Using the mechanism described earlier in this submission. Or using the mechanism of “6”. Or more generally, by any other mechanism.

FIG. 4 does not allocate any time slot to showing the table of trailers on the screen. So as it stands, FIG. 4 can be seen as applicable to the mechanism of “6”, where there was a separate screen on a side wall. But the reader can readily imagine that in FIG. 4, after trailer A is shown, and before slot A1 is shown, that a table of trailers is shown for some time. Or that the line in the table pertaining to trailer A is shown overlaid on trailer A. With similar remarks for the other trailers.

The theatre could make some measure of the sales of tickets to trailer movie A available in near real time to advertisers. By “measure”, this could mean the number of tickets. Or some quantity proportional or indicative of it. The data might also include the final sales price of the tickets.

An advertiser might have previously implemented methods on its computers, which would use this sales data to bid on the remaining ad slots, prior to the movie starting.

How might the trailer ticket sales be useful to an advertiser? If the advertiser knows the number of tickets sold, this by itself can be a measure of the number of people in the audience. And how engaged they were with the trailer. The more the tickets sold, the more the possible value of a subsequent ad slot.

This can be combined with knowledge about the type of movie shown in trailer A. Suppose it is a romance movie. Then the more tickets sold for it, the greater the value of a later ad slot to a vendor selling compatible items. More than if the vendor just knew that trailer A was for a romance movie.

Consider the ad slot B1, after trailers A and B have shown. Suppose an advertiser knows the numbers of tickets sold for A and B. One use might be to add these and use the total as a proxy for the total engagement or attention span of the audience with the screen.

Another case might be for the advertiser to use knowledge about the movies for the 2 trailers. Suppose the movies share a common theme or are in the same genre. An advertiser selling items compatible with that theme or genre might find greater value in any later ad slots, compared to when it has no such real time sales knowledge.

Another possibility is for the advertiser to conduct sales of its own, also offering group discounts. Consider FIG. 2 again. Now imagine that instead of the table showing trailers, an advertiser has won a non-trailer ad slot and is showing the table. The entries are items that the advertiser sells. The barcode points at the advertiser server. With the caveat that the theatre server might have interposed itself as described earlier. So the barcode URL first goes to the theatre server and then redirects to the advertiser.

### 9: Sound to Transmit URL;

The mechanism of a barcode encoding an URL was used in this submission. It lets a patron get an URL via one click, by scanning the barcode on the projection screen with her mobile device camera. Under the assumption that the mobile device has such a camera.

Another way of the user getting an URL without having to type it is via sound. One means of using sound was pioneered by Bergel et al at University College London. [See the reference.] In short, their method takes data, of arbitrary length, and makes a hash of fixed length. This mapping is stored in a Chirp server on the Internet. They observed that a cellphone plays and records sound. A user, Jane, wanting to transmit the data has a Chirp application on her phone.

Likewise for another user, Bob, wanting to get and decode the sound.

Jane starts the app, which sends her data to the Chirp server and gets back the hash. The app converts the hash to an audible sound that sounds like bird song. Hence “Chirp”. The app plays the sound. Bob, nearby, has started his Chirp app. It records the sound, decodes it to the hash. Then it sends the hash to the Chirp server which returns the original data uploaded to it by Jane.

In this submission, the data is an URL. We observe that a theatre has a very good sound system. That can be heard with high fidelity anywhere in the room.

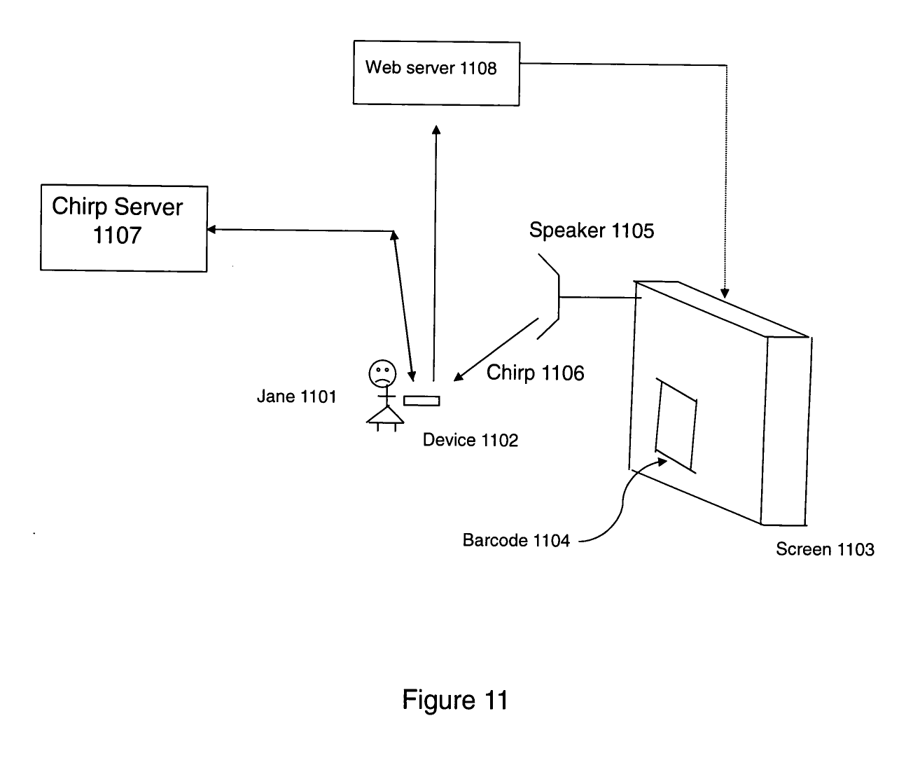

We extend and alter FIG. 1 into FIG. 11. Jane 1101 has Device 1102, near projection Screen 1103. The Screen might still show Barcode 1104, so that other patrons can scan it, as discussed earlier. But now there is Speaker 1105, which transmits Chirp 1106. For clarity, we omitted the steps where the theatre has sent an URL to Chirp Server 1107 and gotten back Chirp 1106.

Jane uses her Device 1102 to record Chirp 1106. Device 1102 decodes and sends the decoded data to Chirp Server 1107. The latter sends the URL to Device 1102. Which brings up a browser and loads it with the URL. Causing a query to Web server 1108. In turn, this can alter Screen 1103.

When FIG. 1 was discussed, it was for the case of the theatre showing the table of FIG. 2, to sell tickets to movie trailers. The theatre might also want to use chirp to maximise the chances that patrons can easily interact.

When only using a barcode on the screen, the audio is not affected. But the video is, because the barcode has to appear somewhere. Likewise, if using chirp, the chirp has to go somewhere in the audio. In FIGS. 7 and 9, we described when and where a barcode could be written into an ad by the theatre.

Thus in FIG. 7, if the advertiser wants chirp to be used, Param 702 can include the necessary parameters telling when in the playing of the ad the chirp should appear. This can be a starting frame, like Frame m in FIG. 8. The ending frame could be omitted. In this case, the theatre would play the chirp at Frame m, till it ended.

Because the chirp is an encoding of a fixed length hash, the advertiser can determine beforehand how many frames past Frame m that the chirp will play.

Another parameter might be a set of starting frames. So the theatre will play the chirp several times during the ad.

A variant is where the theatre might play the chirp after the ad no longer appears on the screen. Suppose a second ad appears on the screen. In general, an advertiser making an ad makes video and audio. If the advertiser gets a slot for its ad, it gets the screen and access to the speakers to play the audio. But suppose an ad has no audio. The advertiser might be willing to give up access to the theatre speakers for some consideration, e.g. money. It could predefine this amount. Then the advertiser of the first ad might be willing to pay that amount, for its audio to be played for some number of times during the second ad.

The theatre would likely make the chirp. Earlier, we discussed how the theatre can append its location, or an identifier of its location, to an URL furnished by the advertiser. It could do that here also. When the final form of the URL has been made, the theatre sends it to the chirp server, which returns a hash. The theatre has a chirp application, which converts the hash to a chirp sound. To be played during the ad.

The theatre can preload the chirp long before the ad is played.

More generally, Param 702 might have the ability to tell the theatre to show a barcode or to play a chirp. One or both choices are possible. If a chirp is used, then the (Video+Barcode) 706 item of FIG. 7 should be understood to also mean the use of a chirp. For brevity, we omit a new figure based on FIG. 7, that explicitly uses chirp.

Likewise, FIGS. 9 and 10 can be altered to include the use of a speaker to transmit a chirp to the patron's device. The discussion of this modifies the earlier text explaining those figures, and parallels what was done in this section for FIGS. 1 and 11.

In this section we spoke of how a chirp application would take a hash from the Chirp server and convert it to a chirp. A variant is where the Chirp server would make the hash and then convert it to a chirp, before sending the latter to an application on a device that would play it.

### 10: Intermission;

For a long movie, there is sometimes an intermission. Of 5 to 10 minutes, say. Typically, dead time. The theatre plays some music and puts up some image on the screen.

The intermission might also have ad slots. Caution is in order here because one distinguishing feature of a theatre compared to television is that there are no ads while the movie is playing. However, by the same token, people put up with commercials on television.

The theatre might show some ads, to extract revenue during this period. As above, the ads can be put out to auction. Either prior to the session, or even dynamically. In the latter case, the choices of ads might not be determined until close to the start of the intermission.

One possibility is to play one or more chirps. Perhaps less intrusive than using the screen to show ads. The euphonic bird song nature of the chirps lends itself to this.

### 11: End of Movie;

This has always been where patrons leave the theatre. Often, the movie credits scroll on the screen. A few diehard patrons might stay to actually read the credits.

Another possibility exists. After the credits, the theatre could show ads, perhaps with a tie-in to the movie. Especially if the ads are interactive, like having a gamification aspect. And where the players might have a chance to win some prizes.

One possibility is that the studio who made the movie puts forth a survey. Accessed by a patron scanning a barcode on the screen or decoding a chirp. Or suppose the studio sells objects depicted in the movie, or tickets to future sequels. The techniques of this submission can be used with the screen.

Another case is where the movie was inspired by a video game. Or the movie or its prequels caused a game to be made, based on it. Imagine that the game can be played on the projection screen, where the players use their phones as game controllers. Entering the game by scanning a barcode or decoding a chirp. Then before the movie, or after it, there might be contests in the theatre room. Not just for those who compete. But for the rest of the audience. It has been found empirically that online, there is a large demand to watch certain types of games.

We claim:

1. A method comprising: displaying a barcode in a theatre, visible by patrons, the barcode comprising an encoded Uniform Resource Locator (URL) of a webpage, where the barcode is displayed on a projection screen; imaging and decoding the barcode with a mobile device connectable with the Internet; opening a browser with the mobile device, wherein the browser displays the webpage according to the URL; via the webpage, selling tickets to movies depicted in movie trailers shown on the projection screen, displaying results of tickets sold to the movies depicted in the movie trailers as a consequence of the movie trailers shown in the theatre; lowering ticket prices if the number of tickets sold as a consequence of the movie trailers shown in the theatre is greater than or equal to a threshold number; and displaying the threshold number and current number of tickets sold as a consequence of the movie trailers shown in the theatre on the projection screen.

2. The method of claim 1, further comprising: displaying the barcode in one or more theatres, where each of the one or more theatres shows a same movie trailer.

3. The method of claim 1, further comprising: varying a plurality of movie trailers across the one or more theatres and/or across different movie sessions; thus maximizing revenue from ticket sales.

4. The method of claim 3, further comprising: playing a plurality of non-movie trailers in addition to the plurality of movie trailers, the one or more theatres varying an order of the plurality of non-movie trailers with the plurality of movie trailers, thus maximizing revenue from ticket sales.

5. The method of claim 1, where the threshold number varies as a function of an estimated number of patrons currently in attendance in the theatre, and/or a function of an estimate number of patrons previously attended in the theatre.

6. The method of claim 1, where the barcode is displayed either before a movie is shown in the theatre or after the movie is shown in the theatre; where the ticket prices after the movie is shown are different from the ticket prices before the movie is shown.

7. The method of claim 1, further comprising: determining a most revenue generating movie trailer by showing a plurality of different movie trailers in a plurality of theatres across a plurality of screenings; and showing the most revenue generating movie trailer in future screenings.

8. The method of claim 1, where the barcode and results are shown interspersed between showings of movie trailers and non-trailer ads.

9. The method of claim 1, where the barcode is shown partially overlaying a showing of a movie trailer or a non-trailer ad.

10. The method of claim 1, where results of ticket purchases for a movie partially overlay a showing of a movie trailer for that movie.

11. The method of claim 1, where the webpage lets a patron buy food or drink.

12. The method of claim 11, where a purchase of a ticket to a movie shown in a trailer is accompanied by the patron receiving food or drink at discounted prices.

13. A method comprising: an online auction by a theatre of an ad time slot; a theatre giving information to advertisers about one or more of (a) a location of the screen, (b) a name of a movie to be shown, (c) day and time of a session, (d) trailers to be shown before the movie, (e) recent attendance in a/the room, (f) start and end times of an ad time slot, (f) recent purchase history by audiences in the room or in other rooms of the theatre; an advertiser successful in the auction furnishing an ad; a showing of the ad by the theatre.

14. The method of claim 13, where a time slot can be of variable duration, subject to some minimum and maximum values.

15. The method of claim 13, where a theatre assigns a value to a time slot for a trailer; where if an advertiser bids more than that value, it can place one or more ads in that time slot.

16. The method of claim 15, where one or more advertisers can collectively bid for a time slot.

17. A method comprising: a theatre receiving one or more of (a) an ad from an advertiser, (b) an URL referring to the advertiser, (c) parameters indicating where in the ad a barcode encoding the URL is to be inserted; the theatre adding an identifier of a screen or a location of the screen, in the URL; the theatre making a barcode from the URL; the theatre inserting the barcode in the ad; the theatre showing the ad on the screen; a patron scanning the barcode with a device; the device decoding the barcode; the device opening a browser and loading the URL.

18. The method of claim 17, where, if the theatre inserted an identifier of the screen, an advertiser server extracts the identifier and queries the theatre server with the identifier; where the theatre server returns the location of the screen.

19. The method of claim 17, where the theatre makes a second URL, that refers to a theatre server; where the theatre stores in memory a mapping from the second URL to the URL from the advertiser; where the barcode is made from the second URL; where a patron device decodes the barcode and queries the theatre server; where the theatre server redirects the query to the URL from the advertiser.

20. The method of claim 17, where the advertiser gets a query from the device; where it returns a web page to the device; where a link or button on the page is picked by the patron; where the advertiser gets this choice; where the advertiser changes the ad; where the advertiser sends the ad to the theatre; where the theatre displays the ad.
